(19) United States
(12) Patent Application Publication
(10) Pub. No.: US 2014/0313213 A1
(43) Pub. Date: Oct. 23, 2014

(54) MEMORY APPARATUS AND METHOD FOR PROCESSING DATA

(71) Applicants: Industry-Academia Cooperation Group Of Sejong University, Seoul (KR); Samsung Electronics Co., Ltd., Suwon-si (KR)

(72) Inventors: Won Chang LEE, Seongnam-si (KR); Gi Ho Park, Seoul (KR); Do Hyung Kim, Hwaseong-si (KR); Shi Hwa Lee, Seoul (KR); Seong Uk Jeong, Seoul (KR)

(73) Assignees: Industry-Academia Cooperation Group Of Sejong University, Seoul (KR); Samsung Electronics Co., Ltd., Suwon-si (KR)

(21) Appl. No.: 14/084,176

(22) Filed: Nov. 19, 2013

(30) Foreign Application Priority Data
Apr. 18, 2013 (KR) 10-2013-0042973

(51) Int. Cl. G06T 1/60

(52) U.S. Cl. CPC G06T 1/60
USPC 345/543; 345/530

(57) ABSTRACT

A memory apparatus may include a tile generator configured to generate a plurality of tiles by dividing a plurality of pixels constituting input data based on a predetermined pixel unit, and a tile storage configured to store the plurality of tiles by sequentially enumerating luminance information and chrominance information about pixels included in the plurality of tiles.

### CROSS-REFERENCE TO RELATED APPLICATIONS

This application claims the priority benefit of Korean Patent Application No. 10-2013-0042973, filed on Apr. 18, 2013, in the Korean Intellectual Property Office, the disclosure of which is incorporated herein by reference.

### BACKGROUND

1. Field

The following description relates to a memory apparatus and a method of processing data.

2. Description of the Related Art

In general, a memory apparatus, such as a dynamic random access memory (DRAM) and an asynchronous DRAM (SDRAM), for example, may include a plurality of banks. A memory address is allocated to each of the plurality of banks.

In general, a memory apparatus may store input data in a memory based on a macro block unit. Data included in each of the consecutive macro blocks may be stored in the same bank.

In the case of reading data stored in a bank in response to an external access to a memory, a memory apparatus may require a reading preparation time for each set of data. Accordingly, when reading a plurality of sets of data stored in the same bank, overhead may increase due to a reading preparation time required for each set of data.

Although a memory access occurs with respect to a portion of data included in a macro block, the memory apparatus may need to read the entire macro block and thus, overhead may increase.

### SUMMARY

The foregoing and/or other aspects may be achieved by one or more embodiments of a memory apparatus which may include a tile generator configured to generate a plurality of tiles by dividing a plurality of pixels constituting input data based on a predetermined pixel unit, and a tile storage configured to store the plurality of tiles by sequentially enumerating luminance information and chrominance information about pixels included in the plurality of tiles.

The foregoing and/or other aspects may be achieved by one or more embodiments of a memory apparatus which may include a first tile generator configured to generate a plurality of main tiles by dividing a plurality of pixels constituting input data based on a predetermined pixel unit, a second tile generator configured to generate a plurality of sub-tiles by dividing the plurality of main tiles based on a predetermined sub-pixel unit, and a tile storage configured to store the plurality of sub-tiles by sequentially enumerating luminance information and chrominance information about pixels included in the plurality of sub-tiles.

The foregoing and/or other aspects may be achieved by one or more embodiments of a method of processing data, in which the method may include generating a plurality of main tiles by dividing a plurality of pixels constituting input data based on a predetermined pixel unit, and storing the plurality of tiles by sequentially enumerating luminance information and chrominance information about pixels included in the plurality of sub-tiles.

Additional aspects and/or advantages of one or more embodiments will be set forth in part in the description which follows and, in part, will be apparent from the description, or may be learned by practice of one or more embodiments of disclosure. One or more embodiments are inclusive of such additional aspects.

### BRIEF DESCRIPTION OF THE DRAWINGS

These and/or other aspects will become apparent and more readily appreciated from the following description of embodiments, taken in conjunction with the accompanying drawings of which:

FIG. 1 illustrates a configuration of a memory apparatus according to one or more embodiments;

FIG. 2 illustrates a configuration of a memory apparatus according to one or more embodiments;

FIG. 3 illustrates a configuration of a memory apparatus according to one or more embodiments;

FIGS. 4A through 4C illustrate diagrams to describe a method of storing input data according to one or more embodiments;

FIGS. 5A through 5C illustrate diagrams to describe a method of storing input data according to one or more embodiments;

FIG. 6 illustrates a diagram to describe a method of storing input data according to one or more embodiments using a comparison example;

FIGS. 7A through 7C illustrate diagrams to describe a method of storing input data according to one or more embodiments;

FIG. 8 illustrates a diagram to describe a method of tiling input data according to one or more embodiments; and

FIGS. 9A and 9B illustrate diagrams to describe a method of reading and transmitting data in response to a memory access according to one or more embodiments.

### DETAILED DESCRIPTION

Reference will now be made in detail to one or more embodiments, illustrated in the accompanying drawings, wherein like reference numerals refer to like elements throughout. In this regard, embodiments of the present invention may be embodied in many different forms and should not be construed as being limited to embodiments set forth herein, as various changes, modifications, and equivalents of the systems, apparatuses and/or methods described herein will be understood to be included in the invention by those of ordinary skill in the art after embodiments discussed herein are understood. Accordingly, embodiments are merely described below, by referring to the figures, to explain aspects of the present invention.

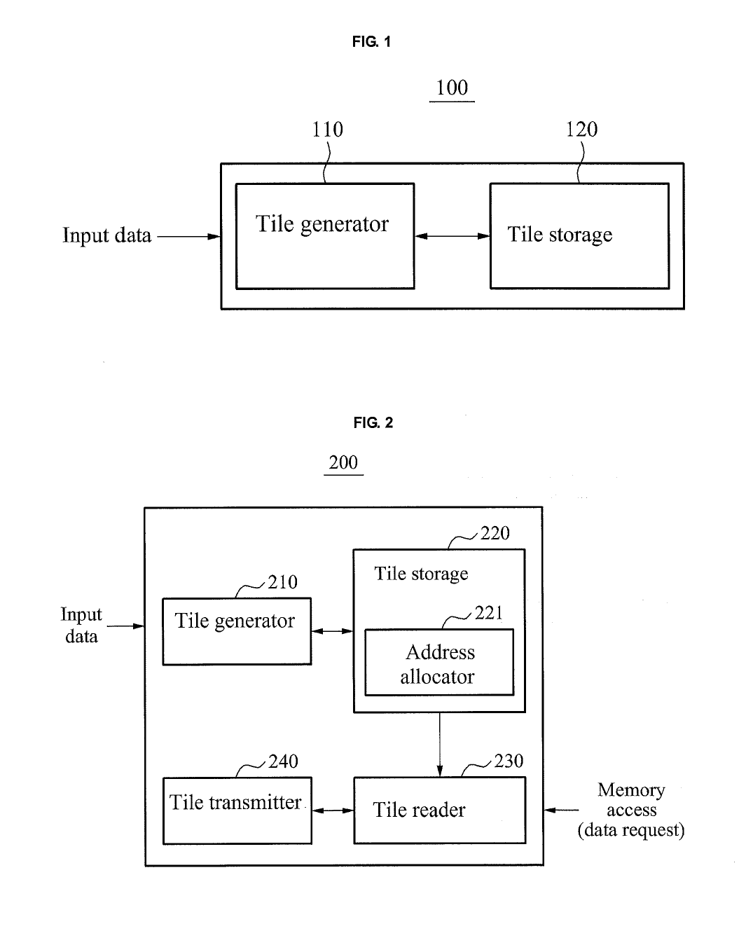

FIG. 1 illustrates a configuration of a memory apparatus 100 according to one or more embodiments.

Referring to FIG. 1, the memory apparatus 100 may include a tile generator 110 and a tile storage 120. When input data is received, the memory apparatus 100 may store the input data by tiling the input data.

Input data may be stored in the memory apparatus 100 based on a plurality of consecutive macro blocks. Each macro block may have a structure in which luminance information (Y) and chrominance information (U and V) about pixels included in a corresponding macro block may be classified and stored.

The memory apparatus 100 may store input data based on a tile unit by dividing a macro block into a plurality of tiles, instead of storing input data based on a macro block unit.

The tile generator 110 may generate a plurality of tiles by dividing a plurality of pixels constituting input data based on a predetermined pixel unit. Accordingly, each tile may include pixel information about a plurality of pixels included in a divided area. The pixel information may include luminance information (Y) and chrominance information (U and V) of a corresponding pixel.

The tile storage 120 may store the plurality of tiles by sequentially enumerating luminance information (Y) and chrominance information (U and V) about pixels included in the plurality of tiles. For example, the tile storage 120 may enumerate luminance information (Y) about pixels included in the plurality of tiles and then enumerate chrominance information (U and V) sequentially. The tile storage 120 may include dummy data after luminance information (Y) and chrominance information (U and V) in order to store a plurality of tiles using a size that may be stored in the memory apparatus 100. The dummy data is to fit for a size of a tile and thus, may be meaningless virtual data.

The tile storage 120 may store, in a single tile, luminance information (Y) and chrominance information (U and V) about pixels that constitute the single tile. Accordingly, in response to a memory access to a portion of data, only a tile including pixels corresponding to the portion of data may be read.

FIG. 2 illustrates a configuration of a memory apparatus 200 according to one or more embodiments.

Referring to FIG. 2, the memory apparatus 200 may include a tile generator 210, a tile storage 220, a tile reader 230, and a tile transmitter 240.

The tile generator 210 may generate a plurality of tiles by dividing a plurality of pixels constituting input data based on a predetermined pixel unit.

The tile storage 220 may store the plurality of tiles by sequentially enumerating luminance information (Y) and chrominance information (U and V) about pixels included in the plurality of tiles.

The tile storage 220 may include an address allocator 221 configured to allocate a memory address for storing the plurality of tiles. The address allocator 220 may allocate different memory addresses to the plurality of tiles.

The tile storage 220 may store the plurality of tiles in the allocated memory address. The tile storage 220 may sequentially store consecutive tiles in a horizontal direction based on the memory address, or may sequentially store consecutive tiles in a vertical direction based on the memory address.

In response to a memory access to a portion of input data, the tile reader 230 may read at least one tile including pixels corresponding to the portion of input data from the tile storage 220. For example, a memory access may occur with respect to a portion of data included in a macro block that constitutes input data. In this example, the tile reader 230 may selectively read only tiles that include pixels corresponding to the portion of data from among a plurality of tiles.

The tile transmitter 240 may transmit, to a unit in which the memory access has occurred, the tiles selectively read by the tile reader 230. Accordingly, by tiling input data, by sequentially enumerating luminance information (Y) and chrominance information (U and V) about pixels constituting a corresponding tile, and by storing the tiles, it is possible to selectively read and transmit only a tile corresponding to a memory access when the memory access to a portion of data occurs. Accordingly, the memory apparatus 200 may have enhanced data transmission efficiency.

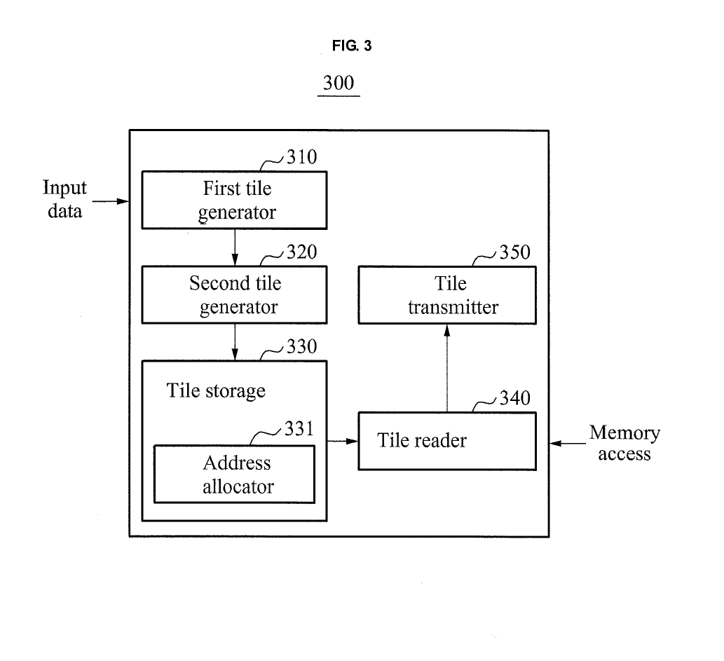

FIG. 3 illustrates a configuration of a memory apparatus 300 according to one or more embodiments.

Referring to FIG. 3, the memory apparatus 300 may include a first tile generator 310, a second tile generator 320, a tile storage 330, a tile reader 340, and a tile transmitter 350.

The first tile generator 310 may generate a plurality of main tiles by dividing a plurality of pixels constituting input data based on a predetermined pixel unit. For example, the first tile generator 310 may generate first through sixth main tiles by dividing input data including 32×12 pixels based on a 16×4 pixel unit.

The second tile generator 320 may generate a plurality of sub-tiles by dividing the plurality of main tiles based on a predetermined sub-pixel unit. For example, the second tile generator 320 may generate first through sixteenth tiles by dividing a single main tile of 16×4 pixels based on a four-pixel unit.

The tile storage 330 may store the plurality of sub-tiles by sequentially enumerating luminance information and chrominance information about pixels included in the plurality of sub-tiles. For example, the tile storage 330 may enumerate luminance information (Y) about pixels constituting the plurality of sub-tiles, and may sequentially enumerate chrominance information (U and V) followed by the luminance information (Y). Also, the tile storage 330 may enumerate dummy data after enumerating the chrominance information (U and V) in order to store the plurality of sub-tiles with a size that may be stored and processed by the memory apparatus 300. Accordingly, a single sub-tile may be configured to be in an order of “luminance information (Y)-chrominance information (U and V)-dummy data” of pixels constituting the single tile.

The tile storage 330 may store the plurality of sub-tiles in the allocated memory address. The address allocator 331 may sequentially store consecutive sub-tiles in a horizontal direction based on the memory address, or may sequentially store consecutive sub-tiles in a vertical direction based on the memory address.

In response to a memory access to a portion of input data, the tile reader 340 may read at least one sub-tile including pixels corresponding to the portion of input data from the tile storage 330.

The tile transmitter 350 may sequentially transmit luminance information and chrominance information about the read at least one sub-tile. For example, when the memory access is associated with a first tile and a second tile that are consecutive, the tile transmitter 350 may transmit luminance information and chrominance information about the first tile and then consecutively transmit luminance information and chrominance information about the second tile.

The memory apparatus 300 of FIG. 3 may transmit data based on a tile unit by tiling input data based on a small pixel unit in response to a memory access by sequentially enumerating luminance information (Y) and chrominance information (U and V) about pixels constituting tiles, and by enumerating the tiles. Accordingly, the memory apparatus 300 may have enhanced data transmission efficiency.

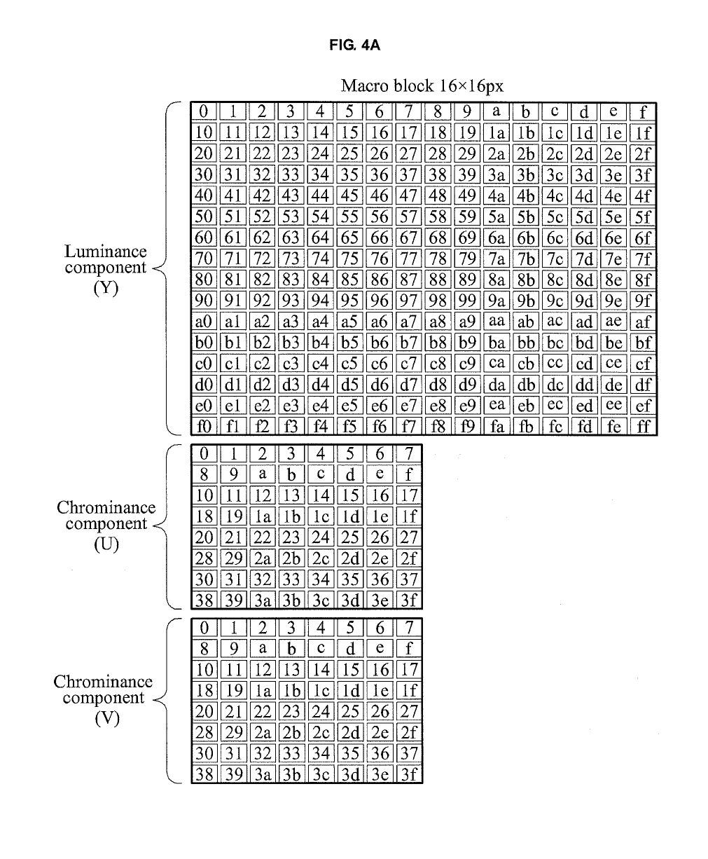

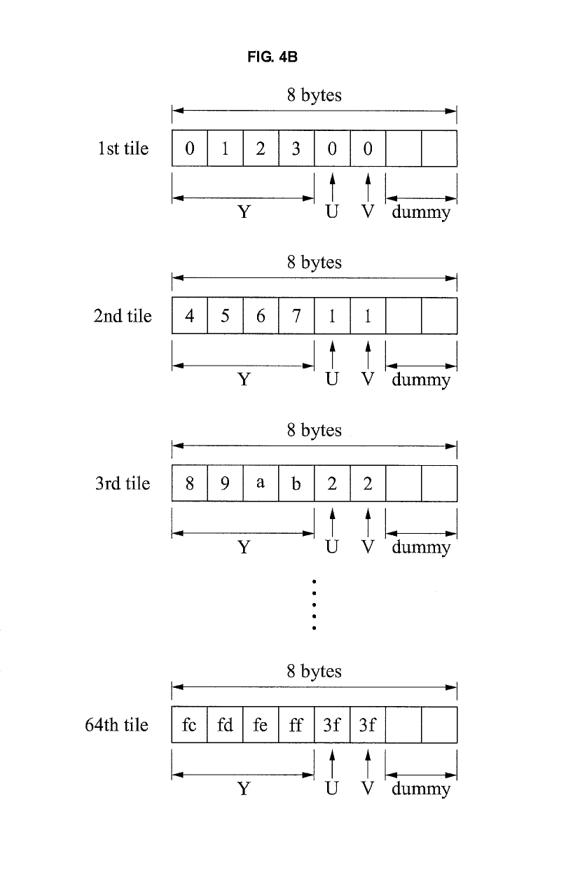

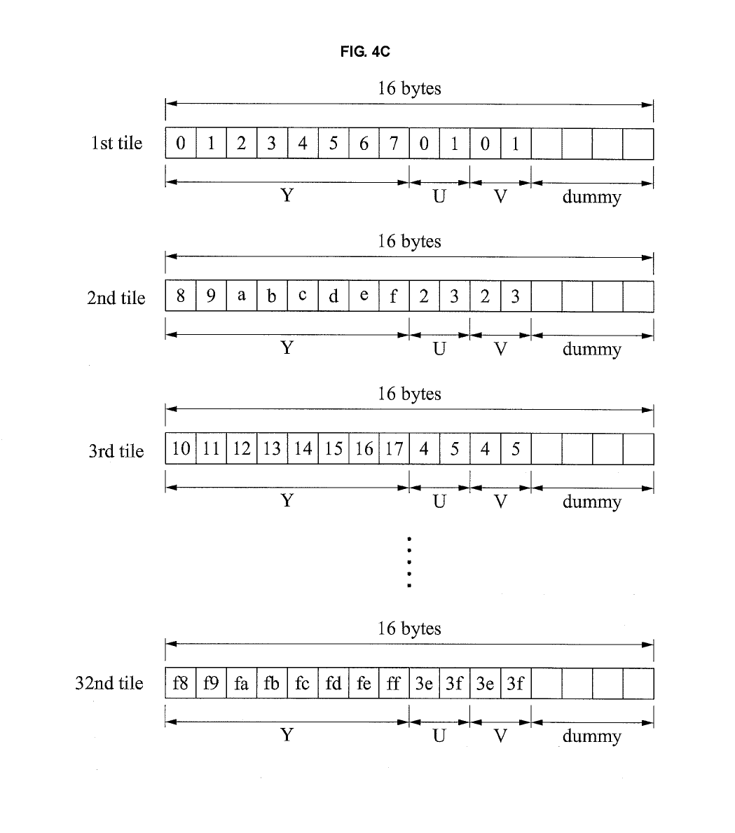

FIGS. 4A through 4C illustrate diagrams to describe a method of storing input data according to one or more embodiments. According to one or more embodiments, processes of storing input data, reading the input data, or transmitting the data to outside may be regarded as data processing.

FIG. 4A illustrates a macro block. Input data may have a plurality of consecutive macro blocks.

A macro block may include luminance information (Y) and chrominance information (U and V) about a plurality of pixels. The luminance information (Y) and the chrominance information (U and V) may be classified and then stored. Referring to FIG. 4A, when a macro block is stored as is, the entire macro block may be read and be transmitted to outside in response to a memory access to a portion of input data included in the macro block. Accordingly, overhead according to the memory access may increase.

FIGS. 4B and 4C are diagrams to describe a method of processing input data according to one or more embodiments.

Referring to FIG. 4B, first through 64^{th} tiles may be generated by dividing a macro block with a size of 16×16 pixels based on a four-pixel unit.

The first tile may be stored by sequentially enumerating luminance information (Y) “0, 1, 2, 3” of four pixels in the macro block, chrominance information (U) “0” of the four pixels, and chrominance information (Y) “0” of the four pixels, and then enumerating dummy data in order to fit for a tile size. In this example, the luminance information (Y) includes four bytes, the chrominance information (U) includes a single byte, the chrominance information (V) includes a single byte, and the dummy data includes two bytes and thus, the first tile may include 8×1 bytes. Similarly, luminance information (Y), chrominance information (U and V), and dummy data may be sequentially enumerated and stored with respect to the second through the 64^{th} tiles.

Referring to FIG. 4C, first through 32^{nd} tiles may be generated by dividing the macro block with the size of 16×16 pixels based on an eight-pixel unit.

The first tile may be stored by sequentially enumerating luminance information (Y) “0, 1, 2, 3, 4, 5, 6, 7” of eight pixels in the macro block, chrominance information (U) “0, 1” of the eight pixels, and chrominance information (V) “0, 1” of the eight pixels, and then enumerating dummy data in order to fit for a tile size. In this example, the luminance information (Y) includes eight bytes, the chrominance information (U) includes two bytes, the chrominance information (V) includes two bytes, and the dummy data includes four bytes and thus, the first tile may include 16×1 bytes. Similarly, luminance information (Y), chrominance information (U and V), and dummy data may be sequentially enumerated and stored with respect to the second through 32^{nd} tiles.

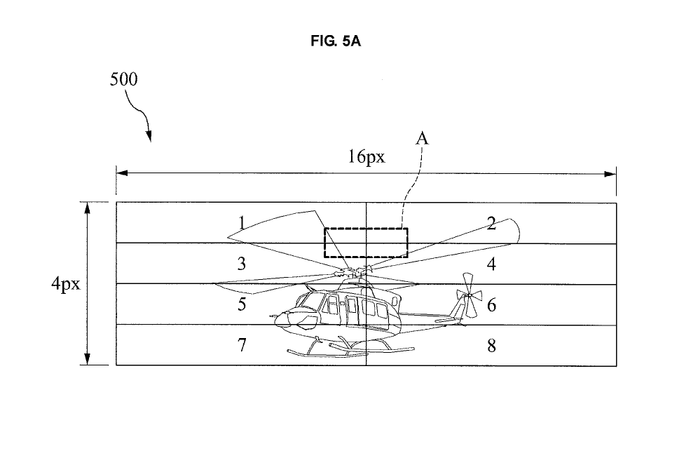

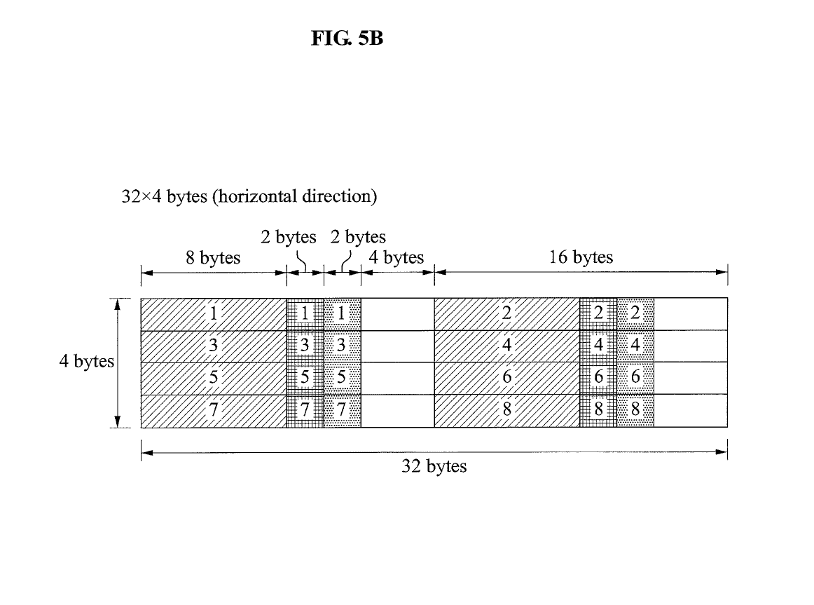

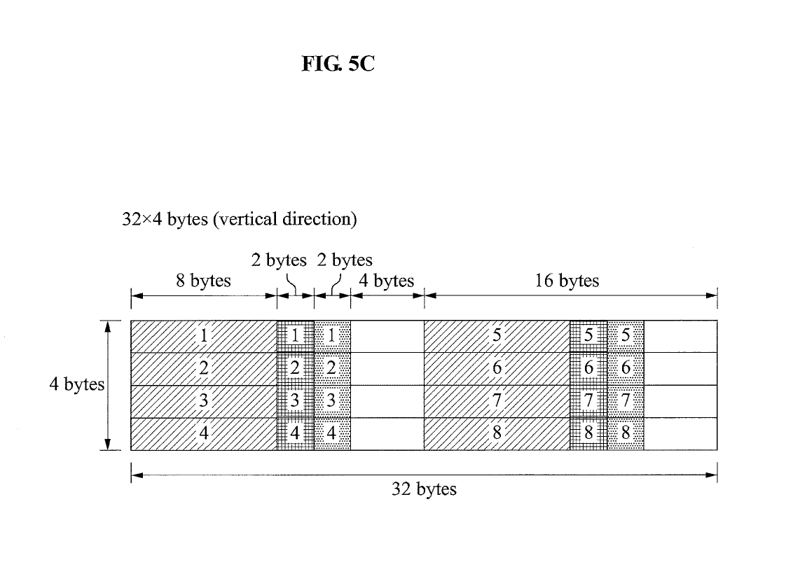

FIGS. 5A through 5C illustrate diagrams to describe a method of storing input data according to one or more embodiments.

FIG. 5A illustrates input data 500 including 16×4 pixels (px). First through eighth tiles may be generated by dividing the input data 500 based on an eight-pixel unit. When storing the first through the eighth tiles, luminance information (Y) and chrominance information (U and V) about each tile may be sequentially enumerated and stored.

Referring to FIGS. 5B and 5C, a single tile may be stored by sequentially enumerating luminance information (Y) of eight pixels, chrominance information (U and V) of the eight pixels, and then enumerating dummy data to fit for a tile size. In this example, the luminance information (Y) includes eight bytes, the chrominance information (U) includes two bytes, and the chrominance information (V) includes two bytes, and the dummy data includes four bytes and thus, a single tile may include 16×1 bytes. Similarly, luminance information (Y), chrominance information (U and V), and dummy data may be sequentially enumerated and stored with respect to the second through the eighth tiles.

Referring to FIG. 5B, the first through the eighth tiles including a total of 32×4 bytes may be sequentially stored in a horizontal direction. Referring to FIG. 5C, the first through the eighth tiles including a total of 32×4 bytes may be sequentially stored in a vertical direction.

When the input data 500 of FIG. 5A is tiled and is stored in the structure of FIG. 5B or 5C, data transmission efficiency according to a memory access may be enhanced. For example, in response to a memory access to pixels constituting the first tile, the memory apparatus may read the first tile and transmit information about the first tile to outside. The first tile includes all of luminance information (Y) and chrominance information (U and V) about the pixels and thus, the memory apparatus may read the first tile and transmit 16×1-bit information corresponding to the first file in a storage structure of FIG. 5B or 5C.

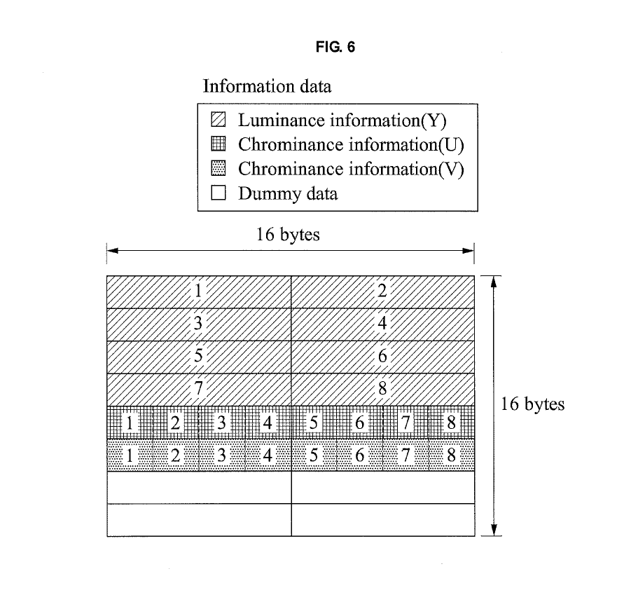

FIG. 6 illustrates a diagram to describe a method of storing input data according to one or more embodiments using a comparison example.

According to the comparison example, when storing the first through the eighth tiles as illustrated in FIG. 5A, storage may be performed by enumerating all of luminance information (Y) of the first through the eighth tiles and then enumerating all of chrominance information (U and V) of the first through the eighth tiles.

For example, referring to FIG. 6, a single tile may include luminance information (Y) and chrominance information (U and V) of the eight pixels. In the comparison example, the first through the eighth tiles may be stored by initially enumerating all of the luminance information (Y) of the first through the eighth pixels, subsequently enumerating all of the chrominance information (U) of the first through the eighth pixels, and then enumerating all of the chrominance information (V) of the first through the eighth pixels, and finally enumerating dummy data to fit for a tile size.

Accordingly, luminance information (Y) and chrominance information (U and V) may be classified and stored with respect to the first through the eighth tiles having a total of 16×16 bytes.

When the input data 500 of FIG. 5A is tiled and is stored in the structure of FIG. 6, data transmission efficiency according to a memory access may be degraded. For example, when a memory access to pixels constituting the first tile occurs in FIG. 5A, the memory apparatus may need to refer to a total of 16×16 bytes. Luminance information (Y) and chrominance information (U and V) of the pixels constituting the first tile are classified and stored and thus, may be read by referring to a total of 16×16 bytes.

According to a storage scheme of FIG. 6, a non-consecutive reference to a total of 16×16 bytes may need to be performed a plurality of times in order to read luminance information (Y) and chrominance information (U and V) of the pixels constituting the first tile and thus, overhead may increase.

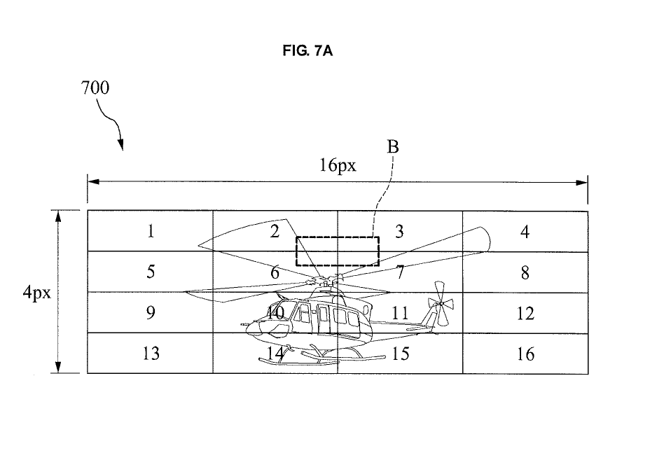

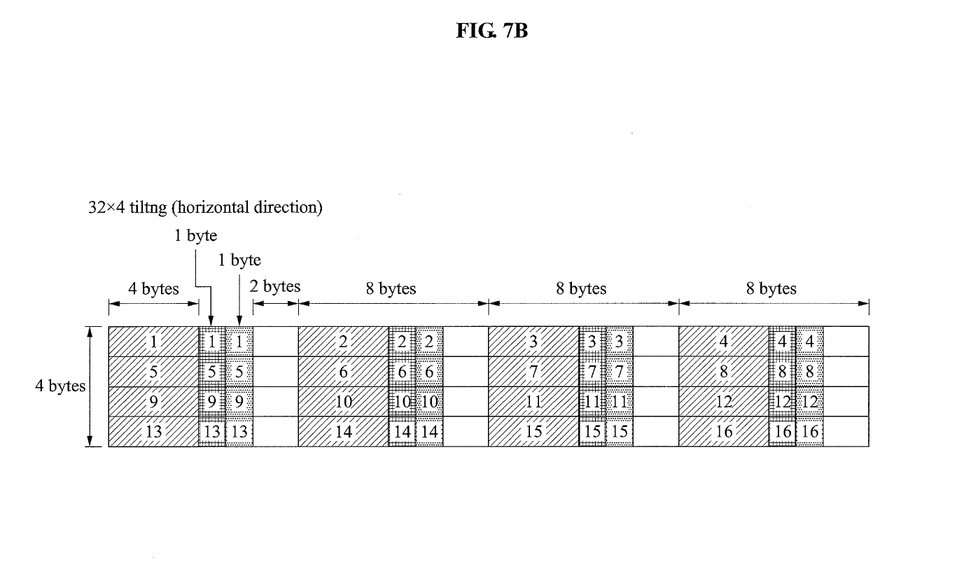

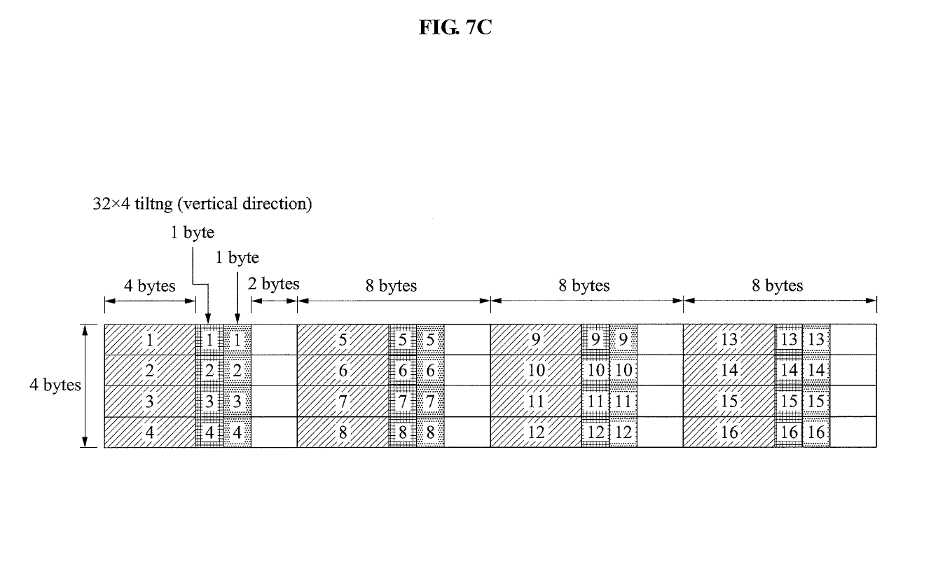

FIGS. 7A through 7C illustrate diagrams to describe a method of storing input data according to one or more embodiments.

FIG. 7A illustrates input data 700 including 16×4 pixels (px). First through sixteenth tiles may be generated by dividing the input data 700 based on a four-pixel unit. According to one or more embodiments, when storing the first through the sixteenth tiles, luminance information (Y) and chrominance information (U and V) about each tile may be sequentially enumerated and stored.

Referring to FIGS. 7B and 7C, a single tile may be stored by sequentially enumerating luminance information (Y) of four pixels and chrominance information (U and V) of the four pixels, and then enumerating dummy data to fit for a tile size. In this example, the luminance information (Y) includes four bytes, the chrominance information (U) includes a single byte, the chrominance information (V) includes a single byte, and the dummy data includes two bytes and thus, a single tile may include 8×1 bytes. Similarly, luminance information (Y), chrominance information (U and V), and dummy data may be sequentially enumerated and stored with respect to the second through the sixteenth tiles.

Referring to FIG. 7B, the first through the sixteenth tiles including a total of 32×4 bytes may be sequentially stored in a horizontal direction. Referring to FIG. 7C, the first through the sixteenth tiles including a total of 32×4 bytes may be sequentially stored in a vertical direction.

Although the input data 700 of FIG. 7A is identical to the input data 500 of FIG. 5A, a pixel unit used for division differs and thus, the number of tiles differs.

For example, the input data 700 of FIG. 7A is divided based on a four-pixel unit and includes 16 tiles and the input data 500 of FIG. 5A is divided based on an eight-pixel unit and includes eight tiles. Even in the case of the same input data, a greater number of tiles may be generated by dividing the input data based on a small pixel unit. In this example, data transmission efficiency according to a memory access may be further enhanced.

For example, when a memory access occurs in an area A of the input data 500 of FIG. 5A, the memory apparatus may read the first tile, the second tile, the third tile, and the fourth tile from the input data 500 and transmit the read tiles to outside. For example, four tiles each having a size of 8×1 bytes may be transmitted.

When a memory access occurs in an area B of the input data 700 of FIG. 7A, the memory apparatus may read the second tile, the third tile, the sixth tile, and the seventh tile and transmit the read tiles to outside. For example, four tiles each having a size of 4×1 bytes may be transmitted.

As described above, even in the case of the same input data, a greater number of tiles may be generated by dividing the input data based on a small pixel unit. In this example, a data transmission amount according to a memory access may be decreased and thus, data transmission efficiency may be enhanced.

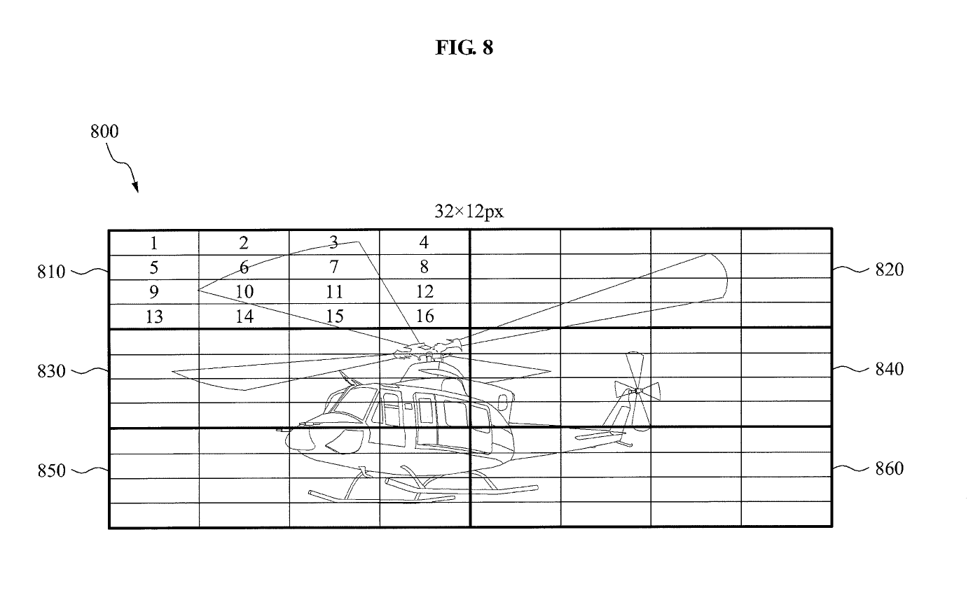

FIG. 8 illustrates a diagram to describe a method of tiling input data according to one or more embodiments. FIG. 8 illustrates input data 800 of 32×12 pixels. A memory apparatus may generate a first main tile 810, a second main tile 820, a third main tile 830, a fourth main tile 840, a fifth main tile 850, and a sixth main tile 860 by dividing the input data 800 based on a 16×4-pixel unit, and may generate a plurality of sub-tiles by dividing the first through the sixth main tiles 810, 820, 830, 840, 850, and 860, based on a predetermined sub-pixel unit.

For example, the memory apparatus may generate first through sixteenth tiles by dividing the first main tile 810 of 16×4 pixels based on a four-pixel unit. In the case of storing the first through the sixteenth tiles, luminance information (Y) and chrominance information (U and V) about pixels constituting each tile may be sequentially enumerated and stored. For example, the storage method of FIGS. 5B and 5C or the storage method of FIGS. 7B and 7C may be employed.

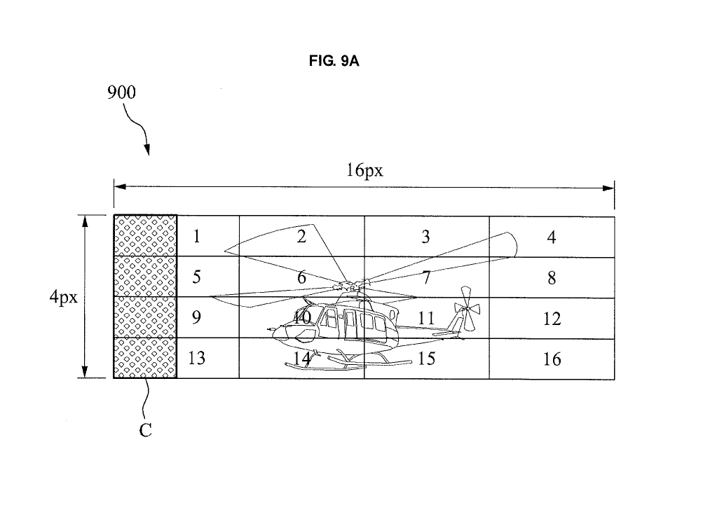

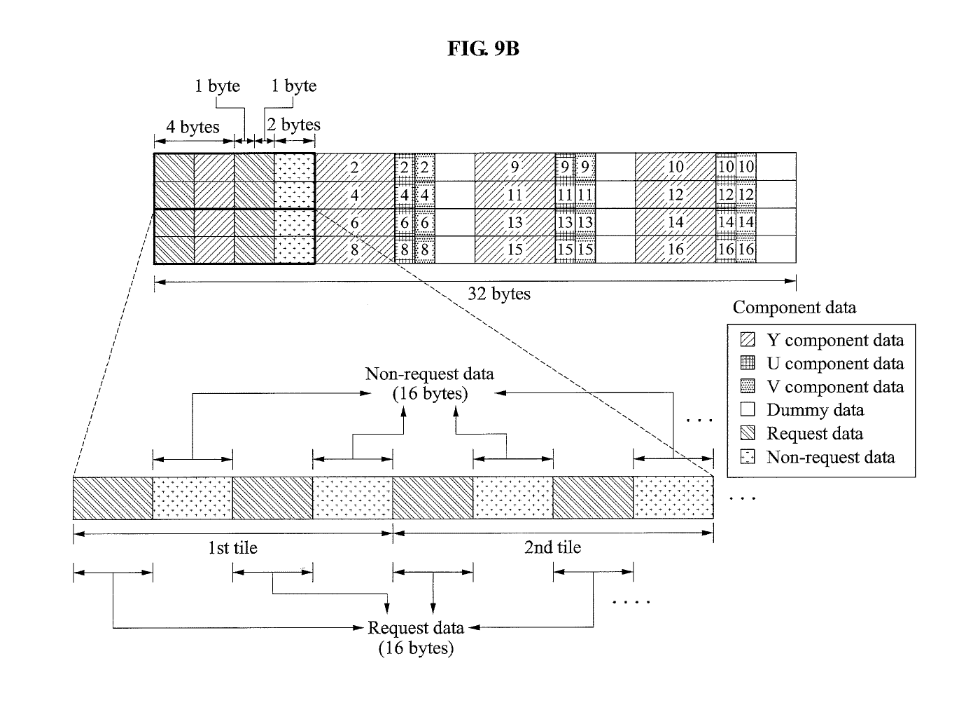

FIGS. 9A and 9B illustrate diagrams to describe a method of reading and transmitting data in response to a memory access according to one or more embodiments.

FIG. 9A illustrates input data 900 of 16×4 pixels (px). The input data 900 is divided based on a four-pixel unit and includes first through sixteenth tiles. With respect to the first through the sixteenth tiles, luminance information (Y) and chrominance information (U and V) about pixels constituting a corresponding tile may be sequentially enumerated and stored.

In response to a memory access to the input data 900 of FIG. 9A, the memory apparatus may verify a tile corresponding to the memory access and then read at least one tile from among the first through the sixteenth tiles and transmit the read at least one tile to outside.

For example, when a memory access occurs in an area C of the input data 900 of FIG. 9A, the memory apparatus may verify the first tile, the fifth tile, the ninth tile, and the thirteenth tile as tiles corresponding to the area C from among the first through the sixteenth tiles, may read the first tile, the fifth tile, the ninth tile, and the thirteenth tile, and may transmit the read first tile, fifth tile, ninth tile, and thirteenth tile to outside.

When transmitting the first tile, the fifth tile, the ninth tile, and the thirteenth tile to outside, the memory apparatus may employ, for example, a transmission method of FIG. 9B.

Initially, the memory apparatus may read the first tile and then transmit the first tile to outside. In this example, the first tile may have a structure in which 4-byte luminance information (Y) of pixels constituting the first tile, 2-byte chrominance information (U and V) thereof, and 2-byte dummy data thereof are sequentially enumerated. The memory apparatus may sequentially transmit the fifth tile, the ninth tile, and the thirteenth tile to outside in succession to the first tile.

In each of the first tile, the fifth tile, the ninth tile, and the thirteenth tile, two pixels may correspond to the area C. Luminance information (Y) and chrominance information (U and V) about the two pixels may be request data according to the memory access. Luminance information (Y) and dummy data corresponding to remaining two pixels may be non-request data. Accordingly, when transmitting the first tile, the fifth tile, the ninth tile, and the thirteenth tile to outside, the request data may have a size of 16 bytes and the non-request data may have a size of 16 bytes.

According to the above data transmission scheme, a ratio of non-request data to request data may decrease and thus, data transmission efficiency may be enhanced.

In one or more embodiments, any apparatus, system, element, or interpretable unit descriptions herein include one or more hardware devices or hardware processing elements. For example, in one or more embodiments, any described apparatus, system, element, retriever, pre or post-processing elements, tracker, detector, encoder, decoder, etc., may further include one or more memories and/or processing elements, and any hardware input/output transmission devices, or represent operating portions/aspects of one or more respective processing elements or devices. Further, the term apparatus should be considered synonymous with elements of a physical system, not limited to a single device or enclosure or all described elements embodied in single respective enclosures in all embodiments, but rather, depending on embodiment, is open to being embodied together or separately in differing enclosures and/or locations through differing hardware elements.

In addition to the above described embodiments, embodiments can also be implemented through computer readable code/instructions in/on a non-transitory medium, e.g., a computer readable medium, to control at least one processing device, such as a processor or computer, to implement any above described embodiment. The medium can correspond to any defined, measurable, and tangible structure permitting the storing and/or transmission of the computer readable code.

The media may also include, e.g., in combination with the computer readable code, data files, data structures, and the like. One or more embodiments of computer-readable media include: magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. Computer readable code may include both machine code, such as produced by a compiler, and files containing higher level code that may be executed by the computer using an interpreter, for example. The media may also be any defined, measurable, and tangible distributed network, so that the computer readable code is stored and executed in a distributed fashion. Still further, as only an example, the processing element could include a processor or a computer processor, and processing elements may be distributed and/or included in a single device.

The computer-readable media may also be embodied in at least one application specific integrated circuit (ASIC) or Field Programmable Gate Array (FPGA), as only examples, which execute (e.g., processes like a processor) program instructions.

While aspects of the present invention have been particularly shown and described with reference to differing embodiments thereof, it should be understood that these embodiments should be considered in a descriptive sense only and not for purposes of limitation. Descriptions of features or aspects within each embodiment should typically be considered as available for other similar features or aspects in the remaining embodiments. Suitable results may equally be achieved if the described techniques are performed in a different order and/or if components in a described system, architecture, device, or circuit are combined in a different manner and/or replaced or supplemented by other components or their equivalents.

Thus, although a few embodiments have been shown and described, with additional embodiments being equally available, it would be appreciated by those skilled in the art that changes may be made in these embodiments without departing from the principles and spirit of the invention, the scope of which is defined in the claims and their equivalents.

What is claimed is:

1. A memory apparatus, comprising:
a tile generator configured to generate a plurality of tiles by dividing a plurality of pixels constituting input data based on a predetermined pixel unit; and
a tile storage configured to store the plurality of tiles by sequentially enumerating luminance information and chrominance information about pixels included in the plurality of tiles.

2. The memory apparatus of claim 1, wherein the tile storage sequentially stores the plurality of tiles in a horizontal direction.

3. The memory apparatus of claim 1, wherein the tile storage sequentially stores the plurality of tiles in a vertical direction.

4. The memory apparatus of claim 1, wherein the tile storage comprises:
an address allocator configured to allocate a memory address for storing the plurality of tiles.

5. The memory apparatus of claim 4, wherein the tile storage stores the plurality of tiles in the assigned memory address.

6. The memory apparatus of claim 1, further comprising:
a tile reader configured to read at least one tile comprising pixels corresponding to a portion of input data from the tile storage in response to a memory access to the portion of input data; and
a tile transmitter configured to sequentially transmit luminance information and chrominance information about the read at least one tile.

7. A memory apparatus, comprising:
a first tile generator configured to generate a plurality of main tiles by dividing a plurality of pixels constituting input data based on a first predetermined pixel unit;
a second tile generator configured to generate a plurality of sub-tiles by dividing each main tile among the plurality of main tiles based on a second predetermined sub-pixel unit; and
a tile storage configured to store the plurality of sub-tiles by sequentially enumerating luminance information and chrominance information about pixels included in the plurality of sub-tiles.

8. The memory apparatus of claim 7, wherein the tile storage sequentially stores a plurality of sub-tiles corresponding to a single main tile in a horizontal direction.

9. The memory apparatus of claim 7, wherein the tile storage sequentially stores a plurality of sub-tiles corresponding to a single main tile in a vertical direction.

10. The memory apparatus of claim 7, wherein the tile storage comprises:
an address allocator configured to allocate a memory address for storing the plurality of sub-tiles.

11. The memory apparatus of claim 10, wherein the tile storage stores the plurality of tiles in the allocated memory address.

12. The memory apparatus of claim 7, further comprising:
a tile reader configured to read at least one sub-tile comprising pixels corresponding to a portion of input data from the tile storage in response to a memory access to the portion of input data; and
a tile transmitter configured to sequentially transmit luminance information and chrominance information about the read at least one sub-tile.

13. A method of processing data, the method comprising:
generating a plurality of main tiles by dividing a plurality of pixels constituting input data based on a first predetermined pixel unit.

14. The method of claim 13, further comprising:
storing the plurality of tiles by sequentially enumerating luminance information and chrominance information about pixels included in the plurality of sub-tiles.

15. The method of claim 14, further comprising:
reading at least one tile comprising pixels corresponding to a portion of input data from among the plurality of tiles in response to a memory access to the portion of input data; and
sequentially transmitting luminance information and chrominance information about the read at least one tile.

16. A non-transitory computer-readable medium comprising a program for instructing a computer to perform the method of claim 13.

17. The method of claim 13, further comprising:
generating a plurality of sub-tiles by dividing each main tile among the plurality of main tiles based on a second predetermined sub-pixel unit.
